(19) United States
(12) Patent Application Publication
(10) Pub. No.: US 2018/0136494 A1
(43) Pub. Date: May 17, 2018

(54) Display Motherboard and Display Panel and Manufacturing Methods Thereof

(71) Applicants: BOE Technology Group Co., Ltd., Beijing (CN); Beijing BOE Optoelectronics Technology Co., Ltd., Beijing (CN)

(72) Inventors: Yang You, Beijing (CN); Kaixuan Wang, Beijing (CN); Yue Li, Beijing (CN); Hongliang Yuan, Beijing (CN)

(73) Assignees: BOE Technology Group Co., Ltd., Beijing (CN); Beijing BOE Optoelectronics Technology Co., Ltd., Beijing (CN)

(21) Appl. No.: 15/550,892

(22) PCT Filed: Feb. 8, 2017
(86) PCT No.: PCT/CN2017/073110

§ 371 Date: Aug. 14, 2017

(30) Foreign Application Priority Data
May 6, 2016 (CN) 201610298530.8

(51) Int. Cl. G02F 1/01; G09F 9/00

(52) U.S. Cl. CPC G02F 1/0105; G09F 9/00

(57) ABSTRACT

A display motherboard and a display panel and manufacturing methods thereof are provided. The manufacturing method of the display motherboard includes: preparing a first substrate which includes a plurality of rows of first sealing regions and a plurality of columns of second sealing regions, the first sealing regions and the second sealing regions intersecting with each other to define a plurality of display regions; and coating sealant along straight lines in the first sealing regions and the second sealing regions of the first substrate.

### TECHNICAL FIELD

The present disclosure relates to a display motherboard and a display panel and manufacturing methods thereof.

### BACKGROUND

Currently, each separate display substrate is generally obtained by cutting one display motherboard. One display region in the display motherboard corresponds to a display region of one display substrate, each display substrate further includes a sealing region surrounding the display region, and a portion between the sealing regions of two adjacent display substrates is a cutting region of the display motherboard.

### SUMMARY

One embodiment of the disclosure provides a manufacturing method of a display motherboard, comprising: preparing a first substrate which includes a plurality of rows of first sealing regions and a plurality of columns of second sealing regions, the first sealing regions and the second sealing regions intersecting with each other to define a plurality of display regions; and coating sealant along straight lines in the first sealing regions and the second sealing regions of the first substrate.

In some examples, extending directions of the first sealing regions and the second sealing regions are perpendicular to each other.

In some examples, each first sealing region and each second sealing region are continuously coated with the sealant along the straight lines.

In some examples, each first sealing region is coated with the sealant along a straight line extending in a row direction, and each second sealing region is coated with the sealant along a straight line extending in a column direction.

In some examples, the manufacturing method further comprises: after coating the sealant, attaching a second substrate to the first substrate, the first substrate and the second substrate being combined with each other by the sealant.

Another embodiment of the disclosure provides a manufacturing method of a display panel, comprising the manufacturing method of the display motherboard as mentioned above.

In some examples, the manufacturing method further comprises: cutting the formed display motherboard along the first sealing regions and the second sealing regions.

In some examples, cutting the formed display motherboard along the first sealing regions and the second sealing regions includes: cutting the formed display motherboard along center lines of the first sealing regions and center lines of the second sealing regions.

Another embodiment of the disclosure provides a display motherboard, wherein the display motherboard is manufactured by the manufacturing method of the display motherboard as mentioned above.

In some examples, the sealant positioned in the first sealing regions and the sealant positioned in the second sealing regions intersect with each other at a right angle.

In some examples, the sealant in the adjacent first sealing regions and the sealant in the adjacent second sealing regions define rectangular display regions.

Another embodiment of the disclosure provides a display panel, wherein the display panel is manufactured by the manufacturing method of the display panel as mentioned above.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a plane schematic diagram of a display motherboard;

FIG. 2 is a plane schematic diagram of a zero-cut display motherboard;

FIG. 3 is a plane schematic diagram of a display motherboard according to an embodiment of the present disclosure;

FIG. 4 is a sectional schematic diagram of the display motherboard according to the embodiment of the present disclosure.

### REFERENCE SIGNS

1—display motherboard; 01—first substrate; 02—second substrate; 10—display substrate; 11—sealant; 12—display region; 13—first sealing region; 14—second sealing region.

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

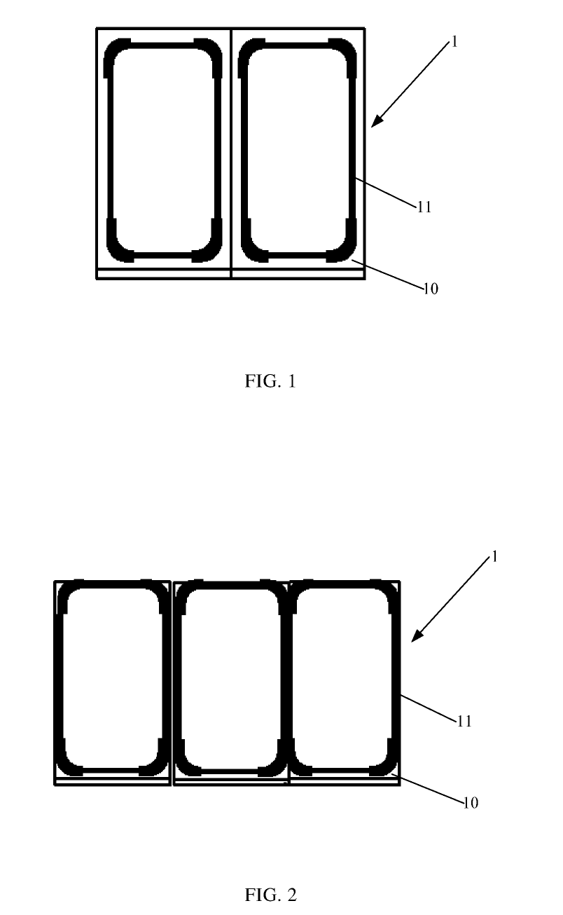

FIG. 1 is a plane schematic diagram of a display motherboard. As illustrated in FIG. 1, sealant 11 on each display substrate 10 on the same display motherboard 1 is generally coated in a mode of carrying out coating on a sealing region of each display substrate 10 one by one, but such coating renders the sealant 11 at four corners of the display substrate 10 relatively thick so as to cause corner light leakage and seriously influence a possibility of mass production. FIG. 2 is a plane schematic diagram of a zero-cut display motherboard. As illustrated in FIG. 2, when such sealant 11 is used for coating the zero-cut (the zero-cut means that a cutting wheel directly cuts glue) display substrate 10, a phenomenon that blank bubbles are generated on corners at an intersection of two display substrates 10, i.e., the sealant 11 cannot cover completely, will also be caused, so that poor cutting of the display motherboard 1 is finally caused.

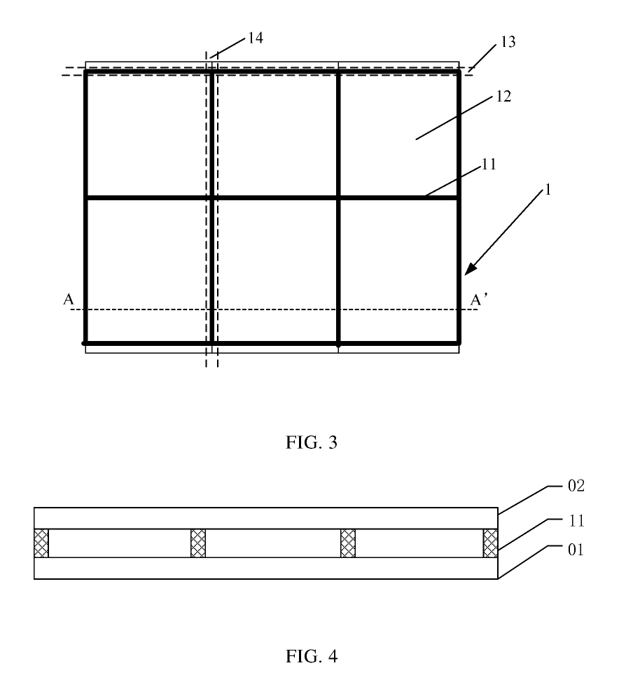

FIG. 3 is a plane schematic diagram of a display motherboard according to an embodiment of the present disclosure. As illustrated in FIG. 3, the embodiment provides a manufacturing method of a display motherboard, wherein the display motherboard 1 includes a plurality of rows of first sealing regions 13 and a plurality of columns of second sealing regions 14, and a plurality of display regions 12 are defined at intersecting positions of the first sealing regions 13 and the second sealing regions 14; and the manufacturing method includes: a step of coating sealant 11 in the first sealing regions 13 and the second sealing regions 14 in a linear coating mode.

For example, a first substrate can be prepared firstly, the first substrate includes a plurality of rows of first sealing regions and a plurality of columns of second sealing regions, and the first sealing regions and the second sealing regions intersect with each other to define a plurality of display regions; and then, the sealant is coated along straight lines in the first sealing regions and the second sealing regions of the first substrate.

It should be noted that in the embodiment, coating sequences of the first sealing regions 13 and the second sealing regions 14 are not limited, and in other words, the second sealing regions 14 can be sequentially coated after the first sealing regions 13 are sequentially coated, the first sealing regions 13 can also be sequentially coated after the second sealing regions 14 are sequentially coated, and certainly, the first sealing regions 13 and the second sealing regions 14 can also be coated alternatively.

In the embodiment, the first sealing regions 13 and the second sealing regions 14 are coated with the sealant 11 in the linear coating mode, and thus, the problem of the thick sealant 11 at four corners of each display region 12 can be fundamentally and effectively reduced, and it can be understood that each display region 12 on the display motherboard 1 corresponds to a display region of a display substrate formed by cutting later, and then the sealant 11 surrounding the display region 12 of the display motherboard 1 corresponds to a sealant 11 of the display substrate formed by cutting later, so that a ratio of light leakage at four corners of the formed display substrate can be reduced. In addition, it can be seen from FIG. 3 that the sealant 11 around the adjacent display regions 12 is shared, so that when the display motherboard 1 is cut to form a display panel, cutting can be carried out along center lines of the first sealing regions 13 and center lines of the second sealing regions 14, and thus, a phenomenon that four corners of the formed display substrate are not fully filled with the sealant 11 can be completely avoided, cutting yield is effectively improved, and possibility of mass production of a zero-cut narrow frame design is increased.

The first sealing regions 13 and the second sealing regions 14 on the display motherboard 1 are perpendicularly arranged, and thus, a plurality of rectangular display regions 12 can be defined, and then a plurality of rectangular display substrates can be formed by cutting. Certainly, directions of the first sealing regions 13 and the second sealing regions 14 can also be limited according to a shape of a product which needs to be formed, as long as extending directions of the two regions are guaranteed to be straight lines.

For example, each first sealing region is coated with the sealant along a straight line extending in a row direction, and each second sealing region is coated with the sealant along a straight line extending in a column direction.

For example, in the process of coating the sealant, each first sealing region and each second sealing region are continuously coated with the sealant along the straight lines. In the embodiment, the sealing regions around each display region are not separately coated, so that the thick sealant on the corners of each display region is avoided.

After the first substrate is coated with the sealant, a second substrate is attached to the first substrate, and the first substrate and the second substrate are combined with each other by the sealant.

For example, the first substrate is an array substrate motherboard, and the second substrate is a color filter substrate motherboard. Or, the first substrate is a color filter substrate motherboard, and the second substrate is an array substrate motherboard. Embodiments of the present disclosure are not specially limited thereto.

FIG. 4 is a sectional schematic diagram of the display motherboard according to the embodiment of the present disclosure. For example, the sectional schematic diagram shows a section sectioned along an A-A′ line in FIG. 3. For example, the first substrate 01 and the second substrate 02 are combined with each other by the sealant therebetween.

Correspondingly, an embodiment further provides a manufacturing method of a display panel, which includes the step of forming the display motherboard 1 and a step of cutting the formed display motherboard 1 along the first sealing regions and the second sealing regions.

The step of cutting the first sealing regions 13 and the second sealing regions 14 of the display motherboard 1 to form display substrates, for example, may be cutting along the center lines of the first sealing regions and the center lines of the second sealing regions to form a plurality of display substrates.

It should be noted that in the embodiment, cutting sequences of the first sealing regions 13 and the second sealing regions 14 are not limited, and in other words, the second sealing regions 14 can be sequentially cut after the first sealing regions 13 are sequentially cut, the first sealing regions 13 can also be sequentially cut after the second sealing regions 14 are sequentially cut, and certainly, the first sealing regions 13 and the second sealing regions 14 can also be cut alternatively.

When the display motherboard 1 is formed, the first sealing regions 13 and the second sealing regions 14 are coated with the sealant 11 in the linear coating mode, and thus, the problem of the thick sealant 11 at four corners of each display substrate 12 can be fundamentally and effectively reduced, so that a ratio of light leakage at four corners of the formed display substrate can be reduced. In addition, it can be seen from FIG. 3 that the sealant 11 around the adjacent display regions 12 is shared, so that when the display motherboard 1 is cut to form the display panel, cutting can be carried out along the center lines of the first sealing regions 13 and the center lines of the second sealing regions 14, and thus, a phenomenon that four corners of the formed display substrate are not full filled with the sealant 11 can be completely avoided, cutting yield is effectively improved, and a possibility of mass production of zero-cut narrow frame design is increased.

Correspondingly, an embodiment further provides a display motherboard and a display panel, both of which are manufactured by the above methods

In the display motherboard, for example, the sealant positioned in the first sealing regions and the sealant positioned in the second sealing regions intersect with each other at a right angle.

In the display motherboard, for example, the sealant in the adjacent first sealing regions and the sealant in the adjacent second sealing regions define rectangular display regions.

An embodiment of the present disclosure further provides a display apparatus which includes the display panel.

In the embodiment, the display apparatus can be any product or part with a display function, e.g., a mobile phone, a tablet personal computer, a television, a display, a notebook computer, a digital photo frame, a navigator and the like.

Certainly, the display apparatus in the embodiment also has structures of an outer frame and the like of a conventional display apparatus.

The foregoing embodiments merely are exemplary embodiments of the disclosure, and not intended to define the scope of the disclosure, and the scope of the disclosure is determined by the appended claims.

The present application claims priority of the Chinese Patent Application No. 201610298530.8 filed on May 6, 2016, the disclosure of which are incorporated herein by its reference in its entirety as part of the present application.

1. A manufacturing method of a display motherboard, comprising:
preparing a first substrate which includes a plurality of rows of first sealing regions and a plurality of columns of second sealing regions, the first sealing regions and the second sealing regions intersecting with each other to define a plurality of display regions; and
coating sealant along straight lines in the first sealing regions and the second sealing regions of the first substrate.

2. The manufacturing method of the display motherboard according to claim 1, wherein extending directions of the first sealing regions and the second sealing regions are perpendicular to each other.

3. The manufacturing method of the display motherboard according to claim 1, wherein each first sealing region and each second sealing region are continuously coated with the sealant along the straight lines.

4. The manufacturing method of the display motherboard according to claim 1, wherein each first sealing region is coated with the sealant along a straight line extending in a row direction, and each second sealing region is coated with the sealant along a straight line extending in a column direction.

5. The manufacturing method of the display motherboard according to claim 1, further comprising: after coating the sealant, attaching a second substrate to the first substrate, the first substrate and the second substrate being combined with each other by the sealant.

6. A manufacturing method of a display panel, comprising the manufacturing method of the display motherboard according to claim 1.

7. The manufacturing method of the display panel according to claim 6, further comprising: cutting the formed display motherboard along the first sealing regions and the second sealing regions.

8. The manufacturing method of the display panel according to claim 7, wherein cutting the formed display motherboard along the first sealing regions and the second sealing regions includes:
cutting the formed display motherboard along center lines of the first sealing regions and center lines of the second sealing regions.

9. A display motherboard, wherein the display motherboard is manufactured by the manufacturing method of the display motherboard according to claim 1.

10. The display motherboard according to claim 9, wherein the sealant positioned in the first sealing regions and the sealant positioned in the second sealing regions intersect with each other at a right angle.

11. The display motherboard according to claim 9, wherein the sealant in the adjacent first sealing regions and the sealant in the adjacent second sealing regions define rectangular display regions.

12. A display panel, wherein the display panel is manufactured by the manufacturing method of the display panel according to claim 6.
